(19) United States
(12) Patent Application Publication
(10) Pub. No.: US 2023/0198608 A1
(43) Pub. Date: Jun. 22, 2023

(54) WIRELESS NETWORK DEVICES, SYSTEMS, AND METHODS

(71) Applicant: Cirrus Design Corporation d/b/a Cirrus Aircraft, Duluth, MN (US)

(72) Inventors: Jeff Fischer, Duluth, MN (US); Brad Cyr, Duluth, MN (US); Doug Young, Duluth, MN (US)

(21) Appl. No.: 18/082,430

(22) Filed: Dec. 15, 2022

Related U.S. Application Data
(60) Provisional application No. 63/290,568, filed on Dec. 16, 2021.
(60) Provisional application No. 63/427,602, filed on Nov. 23, 2022.

(51) Int. Cl. H04B 7/185

(52) U.S. Cl. CPC H04B 7/18506

(57) ABSTRACT

Systems and methods for providing in-flight wireless data access in a cabin of an aircraft. An aircraft communications system by which some data from an airborne network may transfer to an external network through a plurality of data links. The communications system can include a first data connection through which data is allowed to transfer between a first data link or a second data link of the plurality of data links. A connection detector determines an availability of the second data link. A connection manager is configured to prioritize a data transfer using the second data link when the connection detector determines that the second data link is available such that at least some data that would otherwise be transferred through the first data link is rerouted to be transferred through the second data link.

### CROSS-REFERENCE TO RELATED APPLICATIONS

This application claims the benefit of U.S. Provisional Patent Application No. 63/290,568, filed Dec. 16, 2021, and U.S. Provisional Patent Application No. 63/427,602, filed Nov. 23, 2022, both of which are herein incorporated by reference in their entireties and for all purposes.

### FIELD OF THE DISCLOSURE

The present disclosure generally relates to wireless communications, and more specifically, to connection management of wireless communications for aircraft.

### BACKGROUND

Air travel industry demands has led to increased expectations for high-speed, in-flight internet. Travelers increasingly want to stay connected during flights at all levels. Not only do they want to stay connected, but travelers also want their connection to be reliable and fast. In this regard, better connectivity allows for more communication for travelers and with aircraft systems such as safety, communication, and tracking systems.

Various companies have tasked themselves with meeting these demands and have developed systems that promise faster speeds and wider application. Costs associated with these systems, however, vary widely and are often dependent upon how much the system is being used. Thus, equipping an aircraft with in-flight internet can be costly over the lifespan of an aircraft as travelers use in-flight internet during travel. In addition, while some systems are more cost-effective than others, most systems are optimized to work only at certain heights above ground level (AGL), which threatens the reliability of the in-flight internet as the aircraft changes AGL during travel.

### SUMMARY

Disclosed herein are devices, systems, and methods for use in performing data transfers in which some data from an airborne network may transfer to an external network through a plurality of data links. Advantageously, principles disclosed herein are useful for mitigating data costs incurred during data transfers. In this regard, principles of the present disclosure can govern data and control connections between systems and/or system components depending on configurable parameters about data links and a prioritization based on costs of data links. General aspects of devices, systems, methods, and the like that employ principles of the present disclosure can include a first data connection through which data is allowed to transfer between a first data link or a second data link of the plurality of data links, a connection detector that determines an availability of the second data link, and a connection manager that is configured to prioritize a data transfer using the second data link when the connection detector determines that the second data link is available. In this regard, at least some data that would otherwise be transferred through the first data link is rerouted to be transferred through the second data link.

Additional features and advantages of the present disclosure will become apparent to those skilled in the art upon consideration of the following detailed description of the illustrative embodiments exemplifying the disclosure as presently perceived.

### BRIEF DESCRIPTION OF THE DRAWINGS

The above-mentioned and other features and advantages of this disclosure, and the manner of obtaining them, will become more apparent, and will be better understood by reference to the following description of the exemplary embodiments taken in conjunction with the accompanying drawings, wherein:

FIG. 1 is a schematic diagram of an inflight aircraft having an aircraft communications architecture, according to principles of the present disclosure;

FIG. 2 is a schematic, cutaway view of a cabin in the aircraft of FIG. 1;

FIG. 3 is a schematic diagram of different bands of AGL associated with certain data services to be accessed by the aircraft communications architecture, according to principles of the present disclosure;

FIG. 4 is a flowchart of providing in-flight wireless data access in a cabin of an aircraft, according to principles of the present disclosure; and

FIG. 5 is a schematic diagram of a system according to aspects of the present disclosure.

Corresponding reference characters indicate corresponding parts throughout the several views. Although the drawings represent embodiments of various features and components according to the present disclosure, the drawings are not necessarily to scale and certain features can be exaggerated in order to better illustrate and explain the present disclosure. The exemplification set out herein illustrates an embodiment of the invention, and such an exemplification is not to be construed as limiting the scope of the invention in any manner.

### DETAILED DESCRIPTION OF THE DRAWINGS

For the purposes of promoting an understanding of the principles of the present disclosure, reference is now made to the embodiments illustrated in the drawings, which are described below. The exemplary embodiments disclosed herein are not intended to be exhaustive or to limit the disclosure to the precise form disclosed in the following detailed description. Rather, these exemplary embodiments were chosen and described so that others skilled in the art can utilize their teachings. It is not beyond the scope of this disclosure to have a number (e.g., all) the features in a given embodiment to be used across all embodiments.

As an initial matter, as used herein, data service can refer to high-speed data communications, especially those for in-flight aircraft. Such data services commonly use a series of ground-based transmitters in communication with onboard aircraft antennae, although they should not be limited to these examples. It is contemplated that data services include a series of satellite transmitters in communication with onboard aircraft antenna as well. These examples are just some of many example data services. These data servers allow passengers and/or crew on the aircraft and/or the aircraft itself to have high speed data while in flight. In such an arrangement, hardware (e.g., transceivers, antennae, etc.) in an aircraft can be equipped and arranged to provide passengers and/or crew with in-flight Internet (e.g., wireless or Wi-Fi) access. Possible transmission technologies for providing such wireless transmission between the aircraft and a server on the ground may include, for example, commercial 3GPP compliant technology such as 2G, 3G, WiMAX, 4G, LTE, 5G and the like or any other wireless technology. Certain hardware may be industrial IEEE 802.11 or 802.16 wireless devices and the like or any other wireless protocol. In various embodiments, IEEE 802.11a, b, g, n, ac or 802.16f, e, m protocols may be used or any other wireless communication protocol. Accordingly, certain hardware may be in communication with multiple wireless access points during flight of the aircraft. Security protocols such as WEP, WPA, WPA2, and 802.11x, IPSEC, TLS, SSL may be used to secure wireless communications. One skilled in the art would appreciate these and related concepts without needing to discuss them here ad nauseum. Further details about principles of the present disclosure are discussed below.

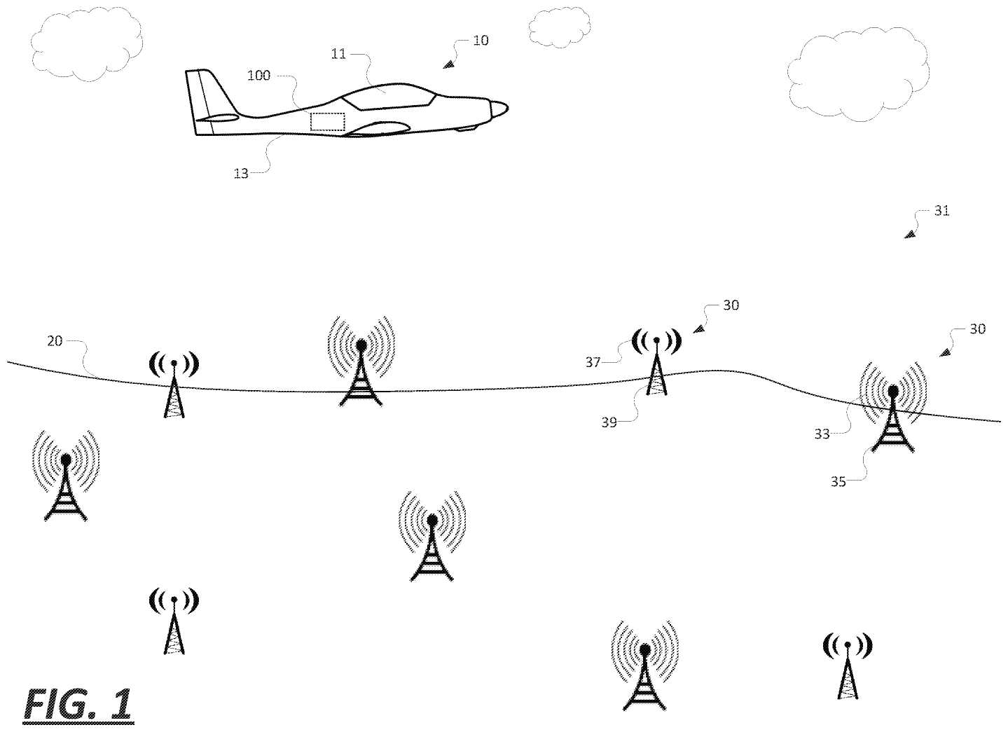

FIG. 1 is a schematic diagram of an in-flight aircraft 10 in an illustrative environment. According to principles of the present disclosure, an aircraft 10 is provided with in-flight wireless data access in its cabin 11. In an implementation employing principles of the present disclosure, an aircraft 10 can include a fuselage 13 that defines the cabin 11. As shown here, the aircraft 10 can be in flight over a terrain 20. The aircraft 10 may also be located on the terrain 20, for example, at an airport. Disposed about the terrain 20 are one or more data services 30 (shown generally at data service 30 and continued without reference at like components). The one or more data services 30 can define a land-based network infrastructure 31 with numerous signal emitting devices, for example a plurality of cell towers such as 4G, 5G, and high-altitude towers. In other examples of network infrastructure, the data services 30 may be produced via satellite signal with numerous air-to-air based transmitters. It is also contemplated that any signal emitting device capable of producing a data services 30 signal such as those listed, or those well known in the art with enough power to reach an aircraft 10, whether in flight or at a position on the terrain 20 may be used. In some examples, signals for the data services 30 that are produced within a network infrastructure may be produced by a one or more data service providers (for example: network providers). These data service providers may apply varying service rates based upon network plans or data service signal frequency for example.

Illustrated here in FIG. 1 is a plurality of data services 30 such as a first data service 33 provided by a first signal emitting device 35 as well as a second data service 37 that is different from the first data service 33 and is provided by a second signal emitting device 39. For example, the first data service 33 can be a high-altitude data service 30, and the second data service 37 can be a low-altitude data service 30. In examples, a high-altitude data service 30 can have a high-altitude data service frequency, and a low-altitude data service 30 has a low-altitude data service frequency. The high-altitude data service frequency can be greater than the low-altitude data service frequency. It is also contemplated that the low-altitude data service frequency may be greater than or equal to the high-altitude data service frequency.

As described above the first data service 33 can have a first service cost (e.g., dollars per unit data used), and the second data service 37 can have a second service cost. The first service cost (e.g., that of the high-altitude data service 30) can be higher than the second service cost (e.g., that of the low-altitude data service 30). Of course, different data services 30 within similar altitudes can have different costs as well, and such circumstances are well within the scope of this disclosure. The aircraft 10 can include aircraft communications architecture 100 that is configured to simultaneously be in communication with the one or more data services 30. This communication can occur regardless of the service cost for accessing the variety of data services 30 (e.g., because costs may not be incurred until a threshold amount of data is transferred over the data service 30). With the aircraft communications architecture 100 in communication with the one or more data services 30, a wireless network can be generated e.g., for use on a myriad of devices (e.g., avionics, computers, mobile devices, wearables, and the like) in the cabin 11.

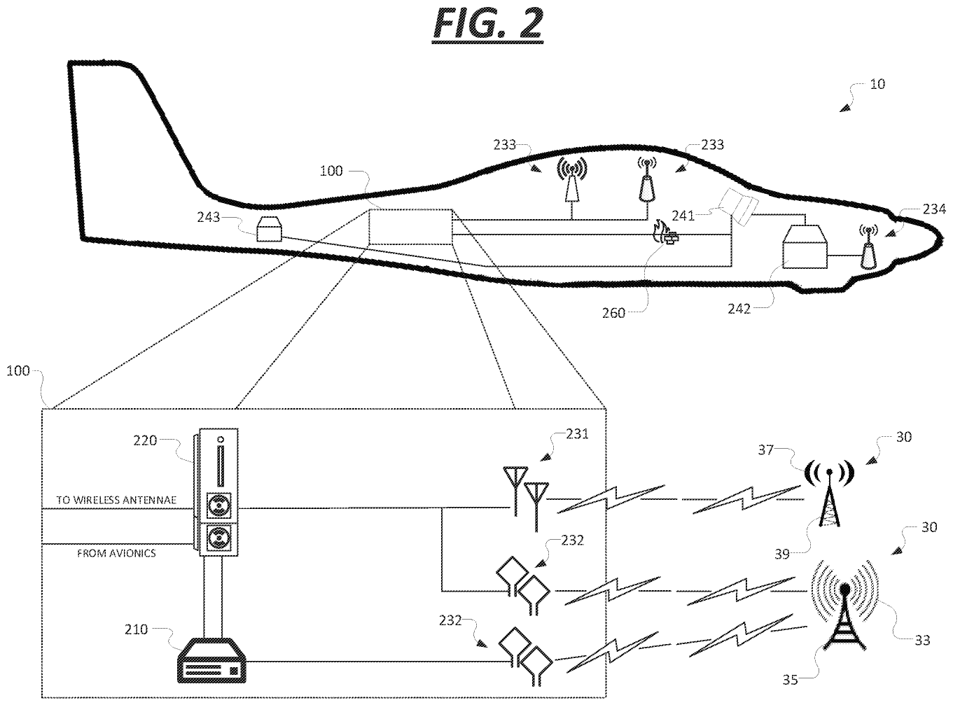

FIG. 2 is a schematic, cutaway view of a cabin 11 in the aircraft 10 of FIG. 1 where the aircraft 10 includes an aircraft communications architecture 100. According to principles of the present disclosure, one or more functions and/or one or more components can define the aircraft communications architecture 100 as further discussed below. With respect to functionality, the aircraft communications architecture 100 can be connectible to a wireless data network (e.g., directly or indirectly connected to a wireless router or a switch via wireless or wired connections). The aircraft communications architecture 100 can receive transmissions from one or more available data services; select a preferred data service of the one or more available data services based on one or more criteria; and/or link at least the preferred data service with an alternate data service in the one or more available data services to facilitate minimizing service interruptions in the wireless data network while prioritizing the preferred data service. The wireless data network can include a passenger network and an aircraft network. The wireless data network can be connectible to communication data streams that include at least two of user data, aircraft control data, aircraft services data, passenger data, aircraft data, avionics data, and in-vehicle systems data.

Performance of the aircraft communications architecture 100 can be governed by a logic that can reference certain criteria. For instance, the criteria can include one or more (e.g., at least two) of: a quantity of the one or more available data services; a quality of the one or more available data services; and a service cost of the one or more available data services. The logic can include selecting which of the communication data streams to connect to, for instance, for air-to-ground or air-to-air transmission. In examples, the preferred data service has the highest quality of the one or more available data services. Quality can be defined considering a variety of factors, including signal strength, available bandwidth, and the like. These are just some examples of the many example criteria disclosed herein or that would be apparent to one skilled in the art. In examples, the preferred data service has the lowest service cost of the one or more available services. The logic can be more complex in certain examples such that two or more criteria are referenced. For instance, as noted above, the one or more available data services can include a first data service (e.g., high- or low-altitude data service) and a second data service (e.g., another high- or low-altitude data service), and the first data service can be different from the second data service. In this regard, the first data service can have about the same quality as the second data service, and the first data service can have a lower service cost than the second data service. In some such examples, the preferred data service is the first data service.

Monitoring the criteria may improve performance of the aircraft communications architecture 100. In this regard, the aircraft communications architecture 100 can be configured to monitor the criteria and, optionally, to continuously monitor the criteria. This monitoring can lead to certain aspects of the logic being reperformed such that there is limited time between the change in criteria and adjustments made by the aircraft communications architecture 100. During these times, the aircraft communications architecture 100 can minimize service interruptions. For instance, the aircraft communications architecture 100 can be configured to reperform the logic if a quality of the preferred data service does not satisfy a quality condition and/or if the service cost of the preferred data service does not satisfy a service cost condition. In certain instances, the aircraft communications architecture 100 is configured to reperform the logic more frequently if either of these criteria is not met (e.g., a quality and/or a service cost of the second data service is less preferable to that of the preferred data service). Accommodating user intervention or preferences, the logic in some examples is at least one of programmable by a user and configurable to receive manual input of user intervention (e.g., to edit criteria, select a preferred data service provider, etc.). For instance, in some examples, a user is allowed to prioritize a data service with which to override selection of the preferred data service by the aircraft communications architecture 100.

Perhaps in a more limiting example, the aircraft communications architecture 100 can be configured to facilitate providing in-flight wireless data access to the cabin 11. For instance, the aircraft communications architecture 100 can be configured to obtain flight data that indicates a position (e.g., an altitude of height above ground level (AGL)) of the aircraft 10. It is worth noting that flight data can include data corresponding to service costs (e.g., flight path, altitude, etc.) and other useful data for the aircraft communications architecture 100, such as quality and availability of one or more data services as discussed above. This flight data can be used to determine which of the one or more data services 30 is most appropriate for use in the cabin 11 of the aircraft 10. In addition, or in alternative, the aircraft communications architecture 100 can be configured to select a data service 30 of the one or more data services 30 based on the service cost associated with using each of the data services 30 in the one or more data services 30. In this regard, the aircraft communications architecture 100 can employ logic similar or identical to those discussed elsewhere herein. The aircraft communications architecture 100 can be configured to cause or generate a wireless network in the cabin 11 of the aircraft 10 using the data service 30. This wireless network can be, in examples, a wireless mesh network.

Specific details about components in the illustrated aircraft communications architecture 100 will now be described. In examples, the aircraft communications architecture 100 can include a telematic control unit 210 (e.g., for crash notifications, aircraft tracking, etc.) that is configured to communicate with low-altitude data services 30 and an air-to-ground internet system 220 (e.g., Broadband Direct Air to Ground Communications (DA2GC) and the like) that is configured to communicate with at least one of low-altitude data services 30 and high-altitude data services 30. It is worth noting that the aircraft communications architecture 100 can include SATCOM components for air-to-air communications. The telematic control unit 210 and the air-to-ground internet system 220 can be connected directly via dual links (e.g., via an ethernet connection and a link available discrete connection) and/or via wireless protocols. It should be noted that although shown having a particular arrangement or communication, this disclosure should not be interpreted as limited to this arrangement. One skilled in the art will appreciate that other arrangements, each of which is not shown here for sake of conciseness, that employ principles of the present disclosure are possible and well within the disclosure.

In addition, shown here as in direct or indirect communication with the telematic control unit 210 and/or the air-to-ground internet system 220 are a variety of antennae and network architecture. For instance, a first set of antennae 231 can be configured to communicate with high-altitude data services, e.g., from terrestrial 4G or 5G towers. A second set of antennae 232 can be configured to communicate with low-altitude data services, e.g., cell towers optimized for high altitudes. The first set of antennae 231 is shown as in communication with the air-to-ground internet system 220, and the second set of antennae 232 is shown as in communication with both the air-to-ground internet system 220 and the telematic control unit 210. A third set of antennae 233 can provide either single-band wireless (e.g., Wi-Fi or other suitable connection) signals or multi-ban wireless signals to the cabin 11 and can be in communication with the air-to-ground internet system 220. A fourth set of antennae 234 can provide a secure wireless signal, e.g., to be used for communication among avionics. Such avionics can include a cockpit 241, a datalink 242 (e.g., a datalogger and/or Wi-Fi data link) connected to the cockpit 241 and fourth set of antennae 234, and a recoverable data module 243 connected to the cockpit 241. A firewall 260 may be erected between the passenger network and the aircraft network such that the aircraft network may be more secure than the passenger network (or vice versa). As shown here, the passenger network can include the aircraft communications architecture 100 and the third set of antennae 233 while the aircraft network can include the cockpit 241, the datalink 242, the fourth set of antennae 234, and the recoverable data module 243.

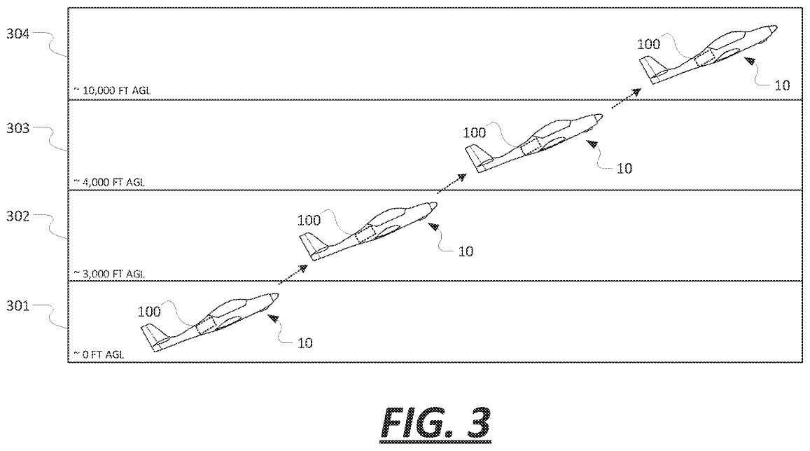

FIG. 3 shows a schematic diagram of different bands of AGL associated with certain data services 30 to be accessed by the aircraft communications architecture 100. As shown here, the aircraft 10 is in ascent and moving through four bands of connectivity as indicated by the dashed arrows. The first band of connectivity 301 is shown between about 0 feet AGL and about 3,000 feet AGL, the second band of connectivity 302 is shown between about 3,000 feet AGL and about 4,000 feet AGL, the third band of connectivity 303 is shown between about 4,000 feet AGL and about 10,000 feet AGL, and the fourth band of connectivity 304 is shown as being above about 10,000 feet AGL. It should be noted that these bands of connectivity may differ across embodiments and the number of bands and their associated AGL will vary across examples depending on the desired types and number of data services. In addition, similar or different arrangements of connectivity bands may be provided for the descent of the aircraft 10 (not shown here). Further it is noted that the connectivity bands may have minimal or significant overlap with one another in relation to the specified AGL it is associated with. These example overlaps may also have areas of increased or decreased signal strengths compared to other segments of the connectivity bands. This disclosure is intended to include all of these variations.

As noted above in the discussion of FIG. 1, here in FIG. 3 the one or more data services can include first and second data services (e.g., a high-altitude data service and a low-altitude data service respectively). In such examples, communicating with the one or more data services can include communicating with a land-based network infrastructure. In examples, communicating with the one or more data services can include communicating with a land-based network infrastructure that comprises a network of air-to-ground cell towers. Of course, as noted elsewhere herein, air-to-air communications are contemplated herein. As noted elsewhere herein, the one or more data services can define a land-based network infrastructure with numerous signal emitting devices, for example a plurality of cell towers such as 4G, 5G, and high-altitude towers. In other examples of network infrastructure, the data services may be produced via satellite signal with numerous air-to-air based transmitters. It is also contemplated that any signal emitting device capable of producing a data services signal such as those listed, or those well known in the art with enough power to reach an aircraft, whether in flight or at a position on the terrain may be used. Continuing with the high- and low-altitude data services example, the high-altitude data service can have a high-altitude data service frequency and the low-altitude data service can have a low-altitude data service frequency. The high-altitude data service frequency can be greater than the low-altitude data service frequency. In examples, the data services may be associated with separate service providers, each of the service providers may have different costs associated with different data service signals.

Particular to the illustrated bands of connectivity, the high-altitude data service can be available in high quality at the first band of connectivity 301 and the fourth band of connectivity 304, in mixed quality at the third band connectivity 303, and unavailable at the second band of connectivity 302. In addition, the low altitude data service can be available in high quality at the first band of connectivity 301 and the second band of connectivity 302, in mixed quality at the third band of connectivity 303, and unavailable at the fourth band of connectivity 304. These variations in connectivity and their associated band of connectivity can be garnered (e.g., during flight and/or on the ground by the aircraft communications architecture or other devices connected thereto) and used to provide consistently high-quality wireless data access to the cabin while the aircraft 10 is in flight and form a link between the data services such that service interruptions and low-quality connections are limited. In this regard, prioritization of data service connections can be performed on the back end of the network while high quality wireless data access is generated on the front end of the network as described elsewhere herein.

Prioritization logic can govern behavior of the aircraft communications architecture 100 as the position of the aircraft 10 and service costs of available data services change during flight or on the ground. This logic can operate similar to other logics discussed elsewhere herein. For instance, the first service cost can be higher than the second service cost with a similar quality for both data services. Under these circumstances, the aircraft communications architecture 100 can be configured to prioritize selecting the second data service (e.g., the low-altitude data service) over the first data service (e.g., the high-altitude data service) when the high-altitude data service is comparable (e.g., in service cost, quality, availability, and the like) to the low-altitude data service. In examples, this logic can prioritize selecting the second data service over the first data service when the second data service is comparable (e.g., in service cost, quality, availability, and the like) to the second data service.

This prioritization logic can define operation modes of the aircraft communications architecture 100. In examples, the aircraft communications architecture 100 can be configured to operate in a low-altitude data service only mode while the position of the aircraft 10 is within a low AGL (e.g., in the first band of connectivity 301 or the first and second bands of connectivity). In examples, the aircraft communications architecture 100 can be configured to operate in a blended data service priority mode while the aircraft 10 is above the low AGL (e.g., in the third band of connectivity 303 or the third and fourth bands of connectivity 303, 304). In examples, the aircraft communications architecture 100 can be configured to operate in a high-altitude data service only mode while the position of the aircraft 10 is above the low AGL (e.g., in the third band of connectivity 303 or the third and fourth bands of connectivity 303, 304). In other embodiments the aircraft communications architecture 100 can operate in a blended priority mode across multiple (e.g., all) bands of connectivity. In such examples, the aircraft communications architecture prioritizes quality and/or service costs of the available data services to form a link between two or more available data services if more than one data service is available. In such instances, a secondary priority of the data service (e.g., quality then service cost or service cost then quality) may be employed.

Several features of this disclosure are worth noting here. In examples, artificial intelligence or other governing logic can be autonomously selected by the aircraft communications architecture 100 based on one or a variety of factors, for example live feeds of the aforementioned criteria used by the aircraft communications architecture while the aircraft is in flight and/or on ground. Machine learning can be used to train the aircraft communications architecture 100 to achieve optimized or calibrated performance thereof. Such criteria of the data services can include signal strength, specific carriers, service costs, broadband type (e.g., 3G, 4G, 5G, etc.), plan specific criteria (e.g., accommodating variable service cost structures), satellite and/or cell tower locations, altitude of the aircraft, etc. As well, prioritization logic can be employed using instructions stored on a non-transitory computer readable medium that can be executed by a processor in the aircraft communications architecture 100. Of course, the aircraft communications architecture 100 can accommodate user preferences by tailoring its prioritization logic to parameters set by the user or the manufacturer for example.

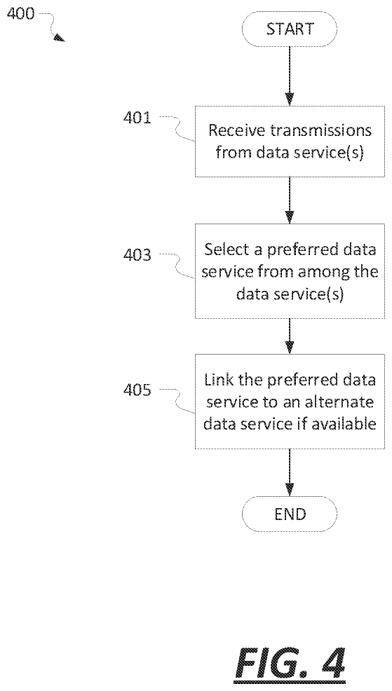

Also disclosed herein are methods of providing in-flight wireless data access in a cabin of an aircraft as shown in the flowchart of FIG. 4. The methods can be similar to the functions of devices disclosed elsewhere herein. In this example, a method 400 can include receiving transmissions from at least one available data service at step 401. The method 400 can include selecting a preferred data service from among the at least one available data services at step 403. This selection can be based on one or more criteria as discussed elsewhere herein. The method 400 can include linking the preferred data service to an alternate data service when an alternate data service is available at step 405. This link can facilitate minimizing service interruptions in the wireless data network while prioritizing the preferred data service, the wireless data network including a passenger network and an aircraft network. In examples, the method 400 can be performed via an aircraft communications architecture similar to those discussed above, such as the aircraft communications architecture 100. As such, it is intended that many (e.g., some or all) of the features discussed above with respect aircraft and the aircraft communications architecture be included here with the method 400. Some examples of this principle are provided below.

As with the above discussed examples of aircraft communications architecture, prioritization logic can be employed here with the method 400. For instance, the criteria can include at least two of: a quantity of the one or more available data services; a quality of the one or more available data services; and a service cost of the one or more available data services. Selection of this criteria can occur at step 403, for examples. The preferred data service can have the highest quality of the one or more available data services. The one or more available data services can include a first data service and a second data service. The first data service can be different from the second data service. In this regard, the first data service can have about the same quality as the second data service, and the first data service can have a lower service cost than the second data service. In some such examples, the preferred data service is the first data service. As with the above discussed examples of aircraft communications architecture, the wireless data network can be connectible to communication data streams that include at least two of user data, aircraft control data, aircraft services data, passenger data, aircraft data, avionics data, and in-vehicle systems data. The logic can include selecting which of the communication data streams to connect to. Other examples of data services, data streams, logic, and the like are discussed above and are equally applicable here with the method 400.

Further, the aircraft communications architecture in some examples can be configured to monitor the criteria. Under some such circumstances the aircraft communications architecture continuously monitors the criteria. The aircraft communications architecture can be configured to reperform the logic if a quality of the preferred data service does not satisfy a quality condition. The one or more available data services can include a first data service and a second data service. The first data service can have a lower service cost than the second data service. The aircraft communications architecture can be configured to reperform the logic more frequently if a quality of the second data service is less preferable to a quality of the preferred data service. In certain examples, the logic is at least one of programmable by a user and configurable to receive manual input of user intervention. A user is allowed to prioritize a data service with which to override selection of the preferred data service by the aircraft communications architecture. Other examples of prioritization logic are discussed above and are equally applicable here with the method 400.

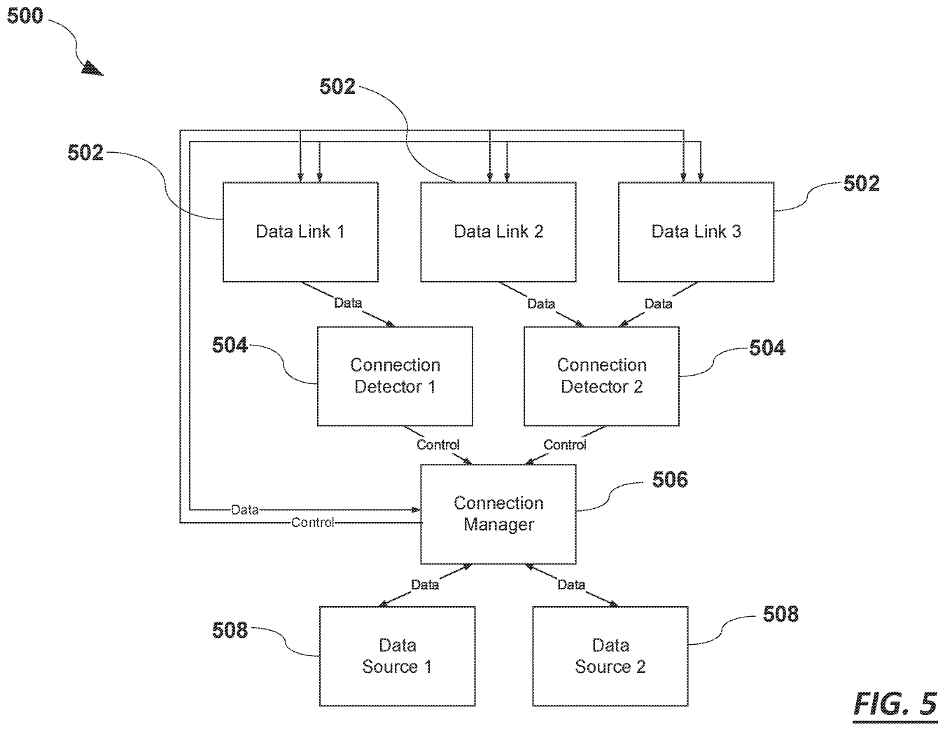

FIG. 5 shows a system 500 according to principles of the present disclosure. Such a system 500 of one or more computers and/or components can be configured to perform particular operations or actions by virtue of having software, firmware, hardware, or a combination of them installed on the system 500 that in operation causes or cause the system 500 to perform the actions. One or more computer programs can be configured to perform particular operations or actions by virtue of including instructions that, when executed by data processing apparatus, cause the apparatus to perform the actions. In this regard, whether in flight, on the ground, or both, the system 500 can function similarly to those aircraft communications architectures discussed elsewhere herein. Communications within the system 500 are indicated by arrows, namely “Data” and “Control” arrows. In particular, the Data arrows indicate information for internal/external transfer or about a system component state. The Control arrows indicate activation, deactivation, and/or availability of a data link 502 for use in data transfer.

System components can be physically independent and/or combined into a single LRU, circuit card, or program, for example. In implementations, the system 500 includes one or more of the following components. The system 500 can include a Data Link 502 that is a wired or wireless data transfer unit, a plurality of which can be differentiated by a unique protocol, frequency, or service plan. The system 500 can include a Connection Detector 504 that determines if an individual data link 502 is available as a data routing option, where the determination is optionally configurable. Examples of configurable parameters include signal quality, geographic location, altitude, and data plans. The system 500 can include a Connection Manager 506 that routes data to configurable prioritization scheme of some or all data links 502. Examples of configurable prioritization can include service cost. The system 500 can include a Data Source 508 that generates data and/or receives end-point data. Examples of data sources include personal electronic devices and LRUs. Although depicted as having certain quantities and/or communications, it should be appreciated that these features may vary without departing from the scope of this disclosure.

Implementations may include one or more of the following features. The first data link 502 is provided via a router that generates the airborne network and the second data link 502 is provided via a telecommunication control unit. The first data link 502 is configured to operate at a higher height above ground level than that of the second data link 502. The first and second data links 502 are air-to-ground data links 502. Implementations of the described techniques may include hardware, a method or process, or computer software on a computer-accessible medium.

To that end, a general aspect of the present disclosure includes a communications connection for use in performing a data transfer in which data from an airborne network is allowed to transfer to an external network through a plurality of data links 502. The communications connection also includes a data connection through which data is allowed to transfer between first and second data links 502 in the plurality of data links 502; a control connection that indicates an availability of the second data link 502; and a connection manager 506 that is configured to determine whether to prioritize performing the data transfer using the second data link 502 when the control connection indicates that the second data link 502 is available such that at least some data that would otherwise be transferred through the first data link 502 is rerouted to be transferred through the second data link 502. Other embodiments of this aspect include corresponding computer systems, methods, apparatus, and computer programs recorded on one or more computer storage devices, each configured to perform one or more of these features.

Configurable prioritization schemes for the communications connection can be based on one or more criteria. The communications connection where the availability of the second data link 502 is based on one or more of the following criteria: a signal strength of the second data link 502; a speed of the second data link 502; and a service cost of the second data link 502. The connection manager 506 dynamically prioritizes performing the data transfer using the second data link 502 when the control connection indicates that the second data link 502 is available based on one or more changes in the criteria. Performing the data transfer via the second data link 502 is cheaper than performing the data transfer via the first data link 502.

Another general aspect of the present disclosure includes an aircraft communications system 500. The aircraft communications system 500 includes a first unit that is configured to perform a first data transfer in which data from an airborne network is allowed to transfer to an external network through a first data link 502; a second unit that is configured to perform a second data transfer in which data from the airborne network is allowed to transfer to an external network through a second data link 502; and a communications connection that facilitates communication between the first and second units. The communications connection can be similar to those discussed elsewhere herein. For instance, the communications connection can include: a data connection through which data is allowed to transfer between the first and second data links 502; a control connection that indicates an availability of the second data link 502; and a connection manager 506 that is configured to determine whether to prioritize performing the first data transfer using the second data link 502 when the control connection indicates that the second data link 502 is available such that at least some data that would otherwise be transferred through the first data link 502 is rerouted to be transferred through the second data link 502.

Similar to the other implementations discussed herein in relation to the communications connection, implementations of the aircraft communications system 500 may include one or more of the following features. The aircraft communications system 500 where the availability of the second data link 502 is based on one or more of the following criteria: a signal strength of the second data link 502; a speed of the second data link 502; and a service cost of the second data link 502. The connection manager 506 dynamically prioritizes performing the data transfer using the second data link 502 when the control connection indicates that the second data link 502 is available based on changes in the criteria. Performing the second data transfer via the second data link 502 is cheaper than performing the first data transfer via the first data link 502. The first unit is a router that generates the airborne network and the second unit is a telecommunication control unit. The first and second data links 502 are air-to-ground data links 502. The first data link 502 is configured to operate at a higher height above ground level than that of the second data link 502. Implementations of the described techniques may include hardware, a method or process, or computer software on a computer-accessible medium.

Another general aspect of the present disclosure includes a method for performing a data transfer. In such data transfers, data from an airborne network is allowed to transfer to an external network through a plurality of data links 502. The method includes controlling, based on an availability of the second data link 502, data that transfers between first and second data links 502 in the plurality of data links 502. The method includes prioritizing performing the data transfer using the second data link 502 when the second data link 502 is available such that at least some data that would otherwise be transferred through the first data link 502 is rerouted to be transferred through the second data link 502.

Similar to the other implementations discussed herein, implementations of the method may include one or more of the following features. The availability of the second data link 502 is based on one or more of the following criteria: a signal strength of the second data link 502; a speed of the second data link 502; and a service cost of the second data link 502. Prioritizing performing the data transfer using the second data link 502 when the second data link 502 is available may include dynamically prioritizing performing the data transfer using the second data link 502 when the second data link 502 is available based on changes in the criteria. Performing the data transfer via the second data link 502 is cheaper than performing the data transfer via the first data link 502. The first data link 502 is provided via a router that generates the airborne network and the second data link 502 is provided via a telecommunication control unit. The first and second data links 502 are air-to-ground data links 502. The first data link 502 is configured to operate at a higher height above ground level than that of the second data link 502. Implementations of the described techniques may include hardware, a method or process, or computer software on a computer-accessible medium.

Another general aspect of the present disclosure includes an aircraft communications system 500 for use in performing data transfers in which some data from an airborne network may transfer to an external network through a plurality of data links 502. The aircraft communications system 500 also includes a first data connection through which data is allowed to transfer between a first data link 502 or a second data link 502 of the plurality of data links 502; a connection detector 504 that determines an availability of the second data link 502, and a connection manager 506 that is configured to prioritize a data transfer using the second data link 502 when the connection detector 504 determines that the second data link 502 is available such that at least some data that would otherwise be transferred through the first data link 502 is rerouted to be transferred through the second data link 502. Other embodiments of this aspect include corresponding computer systems, methods, apparatus, and computer programs recorded on one or more computer storage devices, each configured to perform one or more of these features. Implementations for the aircraft communications system 500 can be similar to those discussed elsewhere herein.

Another general aspect of the present disclosure includes an aircraft network system 500 for use while operating an aircraft. The aircraft network system 500 also includes a first networking module, the networking module including at least one programmable processor capable of buffering and transferring a first set of data, the processor selecting a data transfer path for the first set of data, the first networking module operatively connected to at least a first data offloading antennae; a second networking module capable of generating a wi-fi data network, the second networking module including at least one processor capable of buffering and transferring a second set of data, the second networking module operatively connected to at least a second and third data offloading antennae; a first and second data link 502 located between the first networking module and the second networking module, where the first data link 502 is a ethernet connection between the first networking module and the second networking module and the second data link 502 is a discrete link operable by the first networking module to send the first set of data through the second networking module. Other embodiments of this aspect include corresponding computer systems, methods, apparatus, and computer programs recorded on one or more computer storage devices, each configured to perform one or more of these features. Implementations for the aircraft communications system 500 can be similar to those discussed elsewhere herein.

While the present disclosure has been described as having an exemplary design, the present invention can be further modified within the spirit and scope of this disclosure. This application is therefore intended to cover any variations, uses, or adaptations of the invention using its general principles. Further, this application is intended to cover such departures from the present disclosure as come within known or customary practices in the art to which this invention pertains. Some general guidelines for interpreting the present disclosure are provided here below.

As used herein, the modifier “about” used in connection with a quantity is inclusive of the stated value and has the meaning dictated by the context (for example, it includes at least the degree of error associated with the measurement of the particular quantity). When used in context of a range, the modifier “about” should also be considered as disclosing the range defined by the absolute values of the two endpoints. For example, the range “from about 2 to about 4” also disclosed the range “from 2 to 4.”

It is well understood that methods that include one or more steps, the order listed is not a limitation of the claim unless there are explicit or implicit statements to the contrary in the specification or claim itself. It is also well settled that the illustrated methods are just some examples of many examples disclosed, and certain steps can be added or omitted without departing from the scope of this disclosure. Such steps can include incorporating devices, systems, or methods or components thereof as well as what is well understood, routine, and conventional in the art.

The connecting lines shown in the various figures contained herein are intended to represent exemplary functional relationships and/or physical couplings between the various elements. It should be noted that many alternative or additional functional relationships or physical connections can be present in a practical system. However, the benefits, advantages, solutions to problems, and any elements that can cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone can be present in an embodiment, B alone can be present in an embodiment, C alone can be present in an embodiment, or that any combination of the elements A, B or C can be present in a single embodiment; for example, A and B, A and C, B and C, or A and B and C.

In the detailed description herein, references to “one embodiment,” “an embodiment,” “an example embodiment,” etc., indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but can include other elements not expressly listed or inherent to such process, method, article, or apparatus

1. A communications connection for use in performing a data transfer in which data from an airborne network is allowed to transfer to an external network through a plurality of data links, the communications connection comprising:
a data connection through which data is allowed to transfer between first and second data links in the plurality of data links;
a control connection that indicates an availability of the second data link; and
a connection manager that is configured to determine whether to prioritize performing the data transfer using the second data link when the control connection indicates that the second data link is available such that at least some data that would otherwise be transferred through the first data link is rerouted to be transferred through the second data link.

2. The communications connection of claim 1, wherein the availability of the second data link is based on one or more of the following criteria:
a signal strength of the second data link;
a speed of the second data link; and
a service cost of the second data link.

3. The communications connection of claim 2, wherein the connection manager dynamically prioritizes performing the data transfer using the second data link when the control connection indicates that the second data link is available based on one or more changes in the criteria.

4. The communications connection of claim 1, wherein performing the data transfer via the second data link is cheaper than performing the data transfer via the first data link.

5. The communications connection of claim 1, wherein the first data link is provided via a router that generates the airborne network and the second data link is provided via a telecommunication control unit.

6. The communications connection of claim 1, wherein the first and second data links are air-to-ground data links.

7. The communications connection of claim 5, wherein the first data link is configured to operate at a higher height above ground level than that of the second data link.

8. An aircraft communications system comprising:
a first unit that is configured to perform a first data transfer in which data from an airborne network is allowed to transfer to an external network through a first data link;
a second unit that is configured to perform a second data transfer in which data from the airborne network is allowed to transfer to an external network through a second data link; and
a communications connection that facilitates communication between the first and second units, the communications connection comprising:
a data connection through which data is allowed to transfer between the first and second data links;
a control connection that indicates an availability of the second data link; and
a connection manager that is configured to determine whether to prioritize performing the first data transfer using the second data link when the control connection indicates that the second data link is available such that at least some data that would otherwise be transferred through the first data link is rerouted to be transferred through the second data link.

9. The aircraft communications system of claim 8, wherein the availability of the second data link is based on one or more of the following criteria:
a signal strength of the second data link;
a speed of the second data link; and
a service cost of the second data link.

10. The aircraft communications system of claim 9, wherein the connection manager dynamically prioritizes performing the data transfer using the second data link when the control connection indicates that the second data link is available based on changes in the criteria.

11. The aircraft communications system of claim 8, wherein performing the second data transfer via the second data link is cheaper than performing the first data transfer via the first data link.

12. The aircraft communications system of claim 8, wherein the first unit is a router that generates the airborne network and the second unit is a telecommunication control unit.

13. The aircraft communications system of claim 8, wherein the first and second data links are air-to-ground data links.

14. The aircraft communications system of claim 13, wherein the first data link is configured to operate at a higher height above ground level than that of the second data link.

15. A method for performing a data transfer in which data from an airborne network is allowed to transfer to an external network through a plurality of data links, the method comprising:
controlling, based on an availability of the second data link, data that transfers between first and second data links in the plurality of data links; and
prioritizing performing the data transfer using the second data link when the second data link is available such that at least some data that would otherwise be transferred through the first data link is rerouted to be transferred through the second data link.

16. The method of claim 15, the availability of the second data link is based on one or more of the following criteria:
a signal strength of the second data link;
a speed of the second data link; and
a service cost of the second data link.

17. The method of claim 16, wherein prioritizing performing the data transfer using the second data link when the second data link is available comprises dynamically prioritizing performing the data transfer using the second data link when the second data link is available based on changes in the criteria.

18. The method of claim 15, wherein performing the data transfer via the second data link is cheaper than performing the data transfer via the first data link.

19. The method of claim 15, wherein the first data link is provided via a router that generates the airborne network and the second data link is provided via a telecommunication control unit; and wherein the first and second data links are air-to-ground data links.

20. The method of claim 19, wherein the first data link is configured to operate at a higher height above ground level than that of the second data link.

21. (canceled)

22. (canceled)
